(19) United States
(12) Patent Application Publication
(10) Pub. No.: US 2019/0091659 A1
(43) Pub. Date: Mar. 28, 2019

(54) SORBENT BOOM AND METHOD FOR CONSTRUCTION THEREOF

(71) Applicant: United Sorbents, LLC, Green Bay, WI (US)

(72) Inventor: Donald H. Rogahn, Chisago, MN (US)

(73) Assignee: United Sorbents, LLC, Green Bay, WI (US)

(21) Appl. No.: 16/136,962

(22) Filed: Sep. 20, 2018

Related U.S. Application Data
(60) Provisional application No. 62/562,315, filed on Sep. 22, 2017.

(51) Int. Cl. B01J 20/28; E02B 15/10

(52) U.S. Cl. CPC B01J 20/2804; E02B 15/101; B01J 20/2805

(57) ABSTRACT

A sorbent boom has a bundle having one or more sheets of folded and spun adsorbent material inside of exterior netting surrounding the bundle. The exterior netting secures a rope and has clamped ends with rings and clips so as to permit securing one segment of the sorbent boom to another segment or to another sorbent boom.

### PRIORITY CLAIM AND CROSS-REFERENCE TO RELATED APPLICATION

This application is based on and claims priority to U.S. Provisional Patent Application No. 62/562,315 filed on Sep. 22, 2017, which is incorporated herein by reference in its entirety for all purposes.

### FIELD OF THE INVENTION

The present invention relates in general to barriers used to contain, divert, deflect, or block a substance and, in particular, to sorbent booms and a method for construction thereof.

### BACKGROUND

After a gas or oil spill, containing and removing the spilled pollutant in a timely manner is extremely important to preventing further contamination. Such efforts can require the use of booms, which act as barriers to the leaked pollutant to collect, contain, or divert the spillage. Sorbent booms generally have a cylindrical shape and can be made of adsorbent material to collect the leaked oil or gas. To contain or divert the pollutant, multiple sorbent booms are often linked together to surround the pollutant and create a barrier within which the pollutant is unable to escape.

FIG. 1A shows a prior art boom 10. As the water moves through the boom, the pollutant in the water is pushed into the boom for collection. FIG. 1B shows an inside portion of the prior art boom of FIG. 1A. The inside of the prior art boom generally includes pieces of ground polypropylene 11. The pieces of ground polypropylene 11 are packed tightly into a sleeve 12, which may also be made from polypropylene, or from nylon. The sleeve 12 with the polypropylene pieces 11 is then placed into an external cover 13, which helps prevent loss of the polypropylene pieces 11 if the sleeve 12 is torn.

Unfortunately, such conventional booms are inefficient at collecting leaked substances. Due to the tightly packed polypropylene pieces, water moves more slowly through the boom, and, oftentimes, the pollutant does not even reach the middle of the boom, regardless of the amount of time the boom remains in the water. An inability to fill the boom with pollutant lengthens clean-up times, increases the labor costs associated with spill response teams, and creates waste, as a portion of the boom, specifically, of the polypropylene pieces, remains unused. Additionally, conventional booms, by nature of their configuration, pose certain risks for further complicating water clean-up efforts. For example, if a prior art boom breaks open during use or removal, the polypropylene pieces can be released, sending chunks of ground polypropylene, likely to now contain at least some amount of pollutant, back into open water in the area being cleaned.

Accordingly, a boom that efficiently collects pollutant is needed. Preferably, the boom is manufactured to eliminate, or at least to minimize, any mess resulting from the ripping or breaking of the boom.

### SUMMARY

In at least one embodiment, a sorbent boom includes: a bundle having one or more sheets of folded and spun adsorbent material, the bundle has a first longitudinal end and a second longitudinal end; an exterior netting surrounding the bundle and having a first excess of netting at the first longitudinal end and a second excess of netting at the second longitudinal end; a first clamp securing the first excess of netting; a second clamp securing the second excess of netting; a first end ring secured within the first excess of netting; a second end ring secured within the second excess of netting; a rope extending longitudinally along the bundle, secured underneath the exterior netting; and a clip secured to the rope and to the netting, the clip sized to connect to an end ring of another sorbent boom.

The terms used herein should not be interpreted as being limited to specific forms, shapes, or compositions unless specifically indicated as being required. Rather, the parts can have a wide variety of shapes and forms and can be composed of a wide variety of materials. These features of the apparatus and method will become apparent from the detailed description, claims, and accompanying drawings.

### BRIEF DESCRIPTION OF THE DRAWINGS

Embodiments of a sorbent boom are disclosed with reference to the accompanying drawings and are for illustrative purposes only. The sorbent boom is not limited in application to the details of construction or the arrangement of the components illustrated in the drawings. The sorbent boom is capable of other embodiments or of being practiced or carried out in other various ways. In the drawings:

FIG. 1A is a top view of a prior art boom.

FIG. 1B is a top cutaway view showing an inside portion of the prior art boom of FIG. 1A.

FIG. 2A is top view of a sorbent boom according to one embodiment of the present disclosure.

FIG. 2B is a top cutaway view showing an inside portion of the sorbent boom of FIG. 2A.

FIG. 3 is a flow diagram showing a method for constructing the sorbent boom of FIGS. 2A-2B, according to one embodiment of the present disclosure.

FIG.4 is a schematic perspective view of a system for spinning adsorbent material, according to one embodiment of the present disclosure.

FIG.5 is a block diagram showing a method for constructing the sorbent boom of FIGS. 2A-2B, according to one embodiment of the present disclosure.

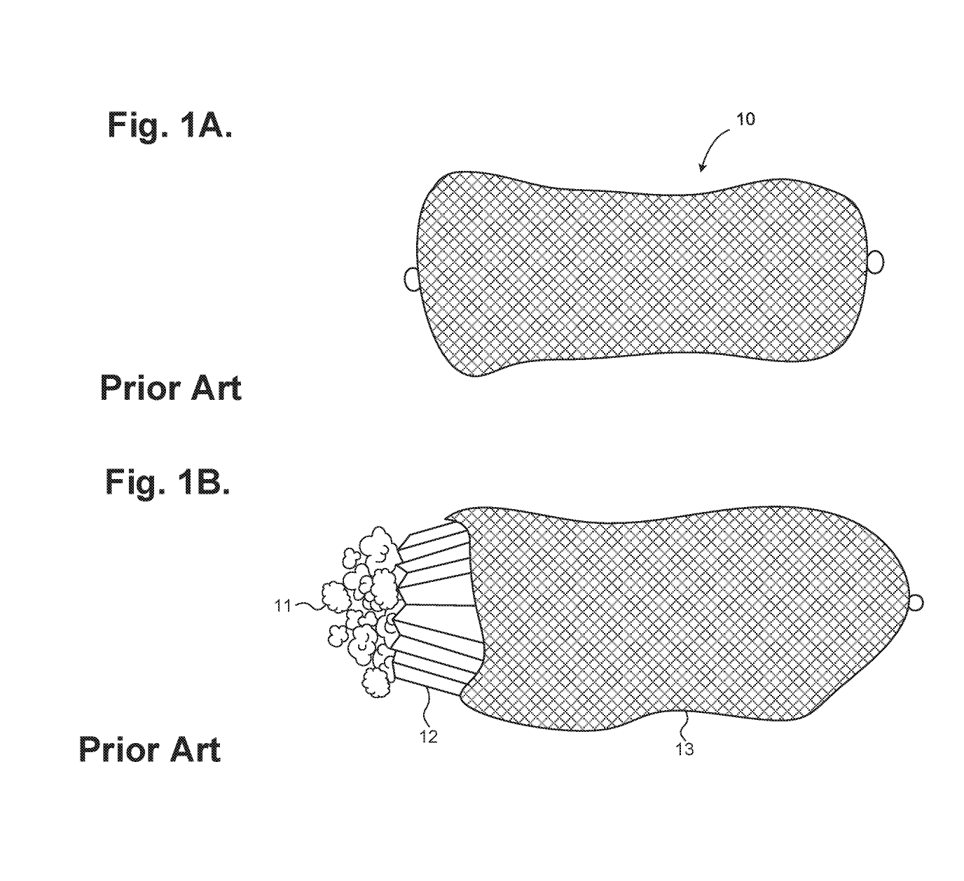

### DETAILED DESCRIPTION

One aspect of the present invention provides a boom including one or more sheets of adsorbent material. The one or more sheets of adsorbent material may be spun and folded during formation of the boom. Each of the one or more sheets of adsorbent material creates a large surface space on which a pollutant can be collected.

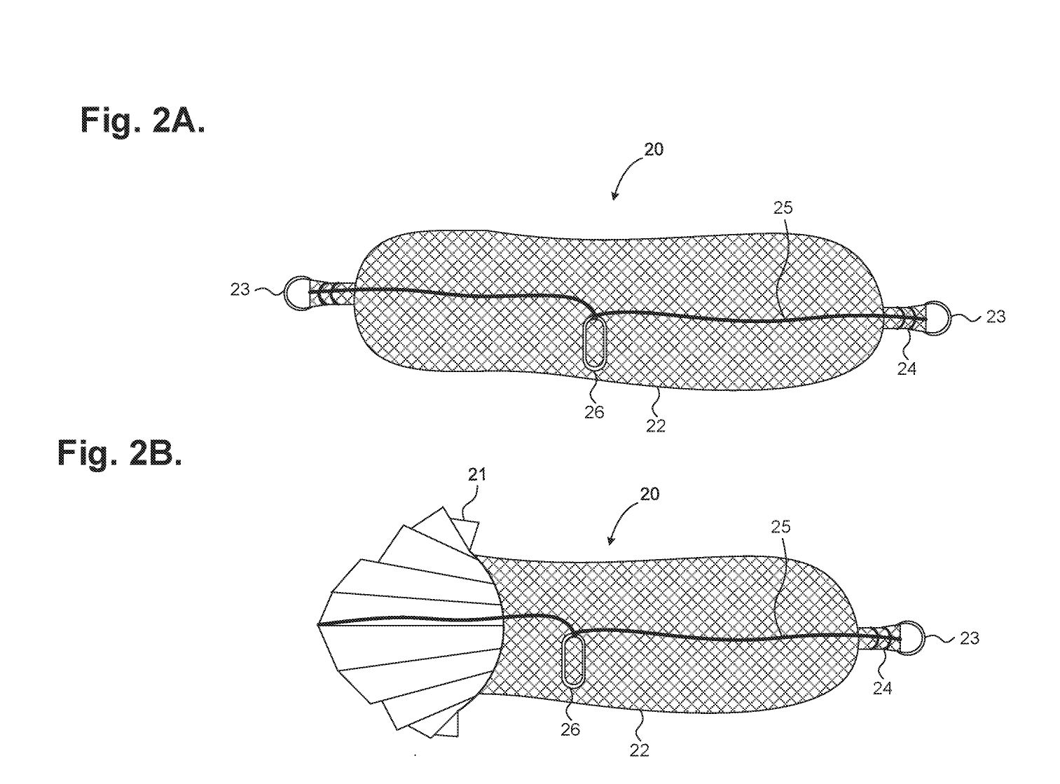

FIG. 2A shows a sorbent boom 20. An outside of the boom 20 includes an external cover 22, which surrounds the one or more sheets of adsorbent material 21 (FIG. 2B). The cover 22 may be comprised of nylon, plastic, polypropylene, and/or other types of material that allow the pollutant to enter the cover 22 and attach to the one or more sheets of adsorbent material 21 as polluted water flows through the boom 20. In the illustrated example, the cover 22 is formed of a mesh or netting material. In a further example, the netting may be formed of a porous plastic material.

In the embodiment shown, the boom 20, when fully composed, forms a generally cylindrical shape with two longitudinal ends. In this embodiment, when the cover 22 initially surrounds the one or more sheets of adsorbent material 21, excess cover material remains at each of the longitudinal ends of the boom 20, and the boom 20 is closed by securing the excess material at each of the longitudinal ends with a clamp 24. The clamp 24 may be comprised of steel, metal, or another type of material or other fastener capable of securely clamping the external cover closed, such that the one or more sheets of adsorbent material 21 cannot escape. On at least one end of the boom 20, a ring 23 may be secured in the cover 22. The ring 23 may be comprised of a metal or steel or other rust-proof material such as plastic. The ring 23 could be circular, semi-circular, or have the ability to selectively open and close.

In this embodiment, a piece of rope 25 is placed longitudinally along the one or more sheets of adsorbent material, beneath the cover 22. In some embodiments, the rope 25 may help strengthen the boom 20. Additionally, as shown in FIGS. 2A-2B, the rope 25 may support at least one clip 26. In some embodiments, the clip may be a carabiner style type clip. In this embodiment, the clip 26 is positioned roughly half way between the two longitudinal ends of the boom 20 and attached to the cover 22 and the rope 25. However, in other embodiments, the clip 26 may be positioned at another location along the boom 20, or other clips may be added to the cover 22 and the rope 25. When it is desired for multiple booms to remain connected while collecting and containing the pollutant, at least one clip 26, attached to the boom 20, may connect to at least one ring 23 of a different boom 20. The size of the boom 20 will depend on a wide range of spill factors, such as a size of a spill, the pollutant spilled, and a location of the spill, either on land or in water.

FIG. 2B shows the sorbent boom of FIG. 2A with a portion of the cover removed in order to show the one or more sheets of adsorbent material 21. In the embodiment shown, the one or more sheets of adsorbent material 21 are spun, folded, and then surrounded by the cover 22. In this embodiment, the one or more sheets of adsorbent material 21 are comprised of polypropylene and are hydrophobic, flexible, lightweight, and buoyant. However, in other embodiments, the one or more sheets of adsorbent material 21 may be comprised of materials having different properties—not all of the above characteristics are required of the adsorbent material in every embodiment. For instance, a sorbent boom designed to rest on solid ground to contain a land spill need not necessarily maintain the same lightweight or buoyant characteristics of a sorbent boom designed to float in a body of water to contain a water spill. In an exemplary embodiment, a weight of a lightweight material may vary from around 0.5 grams per square meter to 65 grams per square meter or 0.3 ounces per square yard to 2.6 ounces per square yard, although other weights are possible.

Unlike prior art booms, the sorbent boom 20 does not require a sleeve to contain its filling material. Specifically, prior art booms are typically filled with ground polypropylene, which are pieces or chunks of polypropylene. Such a design requires an external cover, as well as a sleeve formed from a non-perforated material to contain the polypropylene pieces from falling out of the boom, creating another spill. However, in the embodiment shown in FIG. 2B, rather than ground polypropylene, the one or more sheets of adsorbent material 21 fill the sorbent boom 20. Due to the larger size of each sheet, neither a sleeve, nor any form of non-perforated covering layer is required to contain the one or more sheets of adsorbent material 21. However, some embodiments of the present disclosure may include a sleeve if further reinforcement is desired. Additionally, in the event the cover 22 should tear or break open, the sheets of adsorbent material 21 are unlikely to spill out, further polluting an area a response team is attempting to clean. And should a large enough breakage occur, such that any of the sheets of adsorbent material 21 escape the boom 20, the large sheets of adsorbent material 21 are readily collectible.

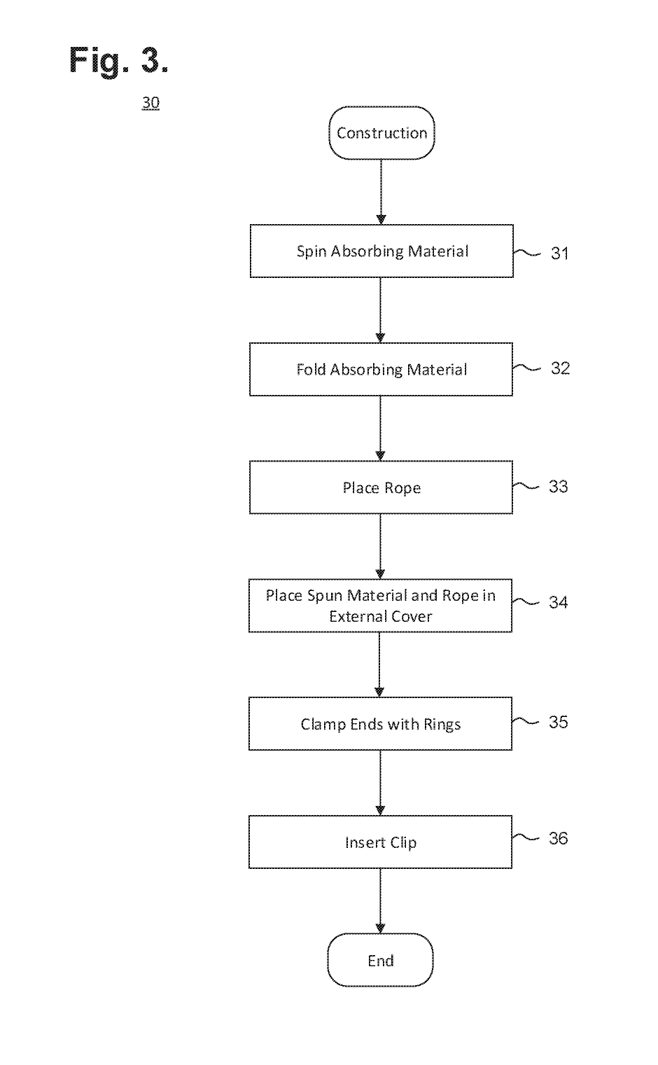

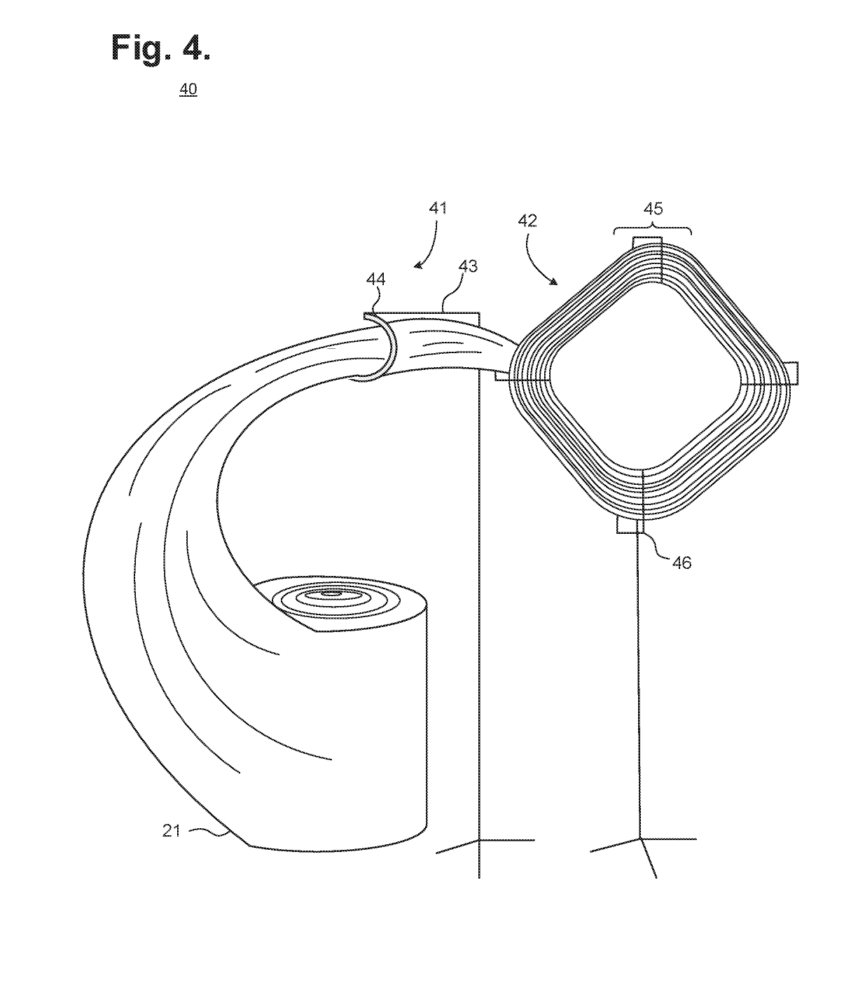

FIG. 3 is a flow diagram showing a method 30 for constructing the sorbent boom 20, in accordance with one embodiment of the present disclosure. According to this method, the one or more sheets of adsorbent material are first spun (block 31). In some embodiments, the adsorbent material may be spun on a spinning wheel, as shown in FIG. 4. A length of the one or more sheets of adsorbent material to be spun is dependent on the size of the boom to be constructed, as further described below with respect to FIG. 4. Utilizing the one or more sheets of adsorbent material creates a larger accessible surface space than exists in conventional booms filled with ground polypropylene. The one or more sheets of adsorbent material efficiently and effectively collect the pollutant, which adheres to the adsorbent material, while water free of the captured pollutant is released through the material.

In the embodiment shown, once fully spun, the adsorbent material is removed from the spinning wheel and folded (block 32) generating one or more folds. In this embodiment, the number of folds is also dependent on the size of the boom and settings on the spinning wheel, described in greater detail below, with reference to FIG. 4.

Additionally, in this embodiment, the rope is placed (block 33) longitudinally along the spun and folded material, and the external cover is then placed (block 34) around the rope and the spun material. Next, both ends of the sorbent boom are closed (block 35) with the clamp and affixed with the ring. Finally, in this embodiment, the clip is affixed (block 36) to the cover and the rope to allow the boom to connect to a ring on another boom. The clip may be affixed at a longitudinal center of the boom or at another location along the boom.

Spinning of the one or more sheets of adsorbent material 21 may occur via a spinning wheel. FIG. 4 shows an exemplary system 40 for spinning the one or more sheets of adsorbent material 21 using a spinning wheel 42. However, in other embodiments, other spinning systems may be used to spin the one or more sheets of adsorbent material 21. In the embodiment shown in FIG. 4, the system 40 includes at least one spool of the one or more sheets of adsorbent material 21, a material guide 41, and a spinning wheel 42. In this embodiment, the material guide 41 includes a stand with an arm 43 affixed to a top of the stand, and a guide 44, such as a hook or a ring, formed at an end of the arm 43, opposite the stand. The spinning wheel 42 may include two or more arms 45. In addition, each arm 45 may include one or more hooks 46 to help collect and guide the one or more sheets of adsorbent material 21. In the embodiment shown, the spinning wheel 42 includes four arms 45, each having one hook 46 positioned at a distal end.

In certain embodiments, the arms 45 may be longitudinally adjustable to form a shape from the one or more sheets of adsorbent material 21 that is larger or smaller. In the embodiment shown, the spinning wheel 42 includes four arms 45, which are used to form a square-like shape of adsorbent material; however, a spinning wheel in a different embodiment may have more or fewer arms and may create a different shape. When the arms 45 are fully extended, the shape formed from the one or more sheets of adsorbent material 21 will be larger than when the arms 45 are more retracted. In an embodiment in which the arms 45 are adjustable, it is best practice for the arms 45 to be further extended when longer booms are desired than when shorter booms are desired.

Before initiating spinning, the one or more sheets of adsorbent material 21 are placed through the guide 44 and secured to one of the arms 45 of the spinning wheel 42. The one or more sheets of adsorbent material 21 may be secured to the arm 45 by a knot, pin, adhesive, or other means. In certain embodiments, more than one spool may be used, and one or more sheets of adsorbent material 21 from each spool may be placed through the guide 44 and secured to the arm 45.

The spinning wheel 42 then rotates to pull the one or more sheets of adsorbent material 21 around the arms 45 and hooks 46, if present. The rotation may occur manually or via a motor or other automated source. Rotation continues until the desired length of the one or more sheets of adsorbent material have been spun. The final length of the one or more sheets of adsorbent material 21 is based, in part, on the size of the sorbent boom 20 to be constructed. For example, booms with greater lengths or greater widths will typically require longer lengths of the one or more sheets of adsorbent material 21. Likewise, such booms will typically also requiring more rotations of the spinning wheel 42. Width of the one or more sheets of adsorbent material 21 may also factor into the required length of the one or more sheets of adsorbent material 21. For example, when the one or more sheets of adsorbent material 21 are wider, a shorter length may be required to construct a boom of a given size than when the one or more sheets of adsorbent material 21 are narrower.

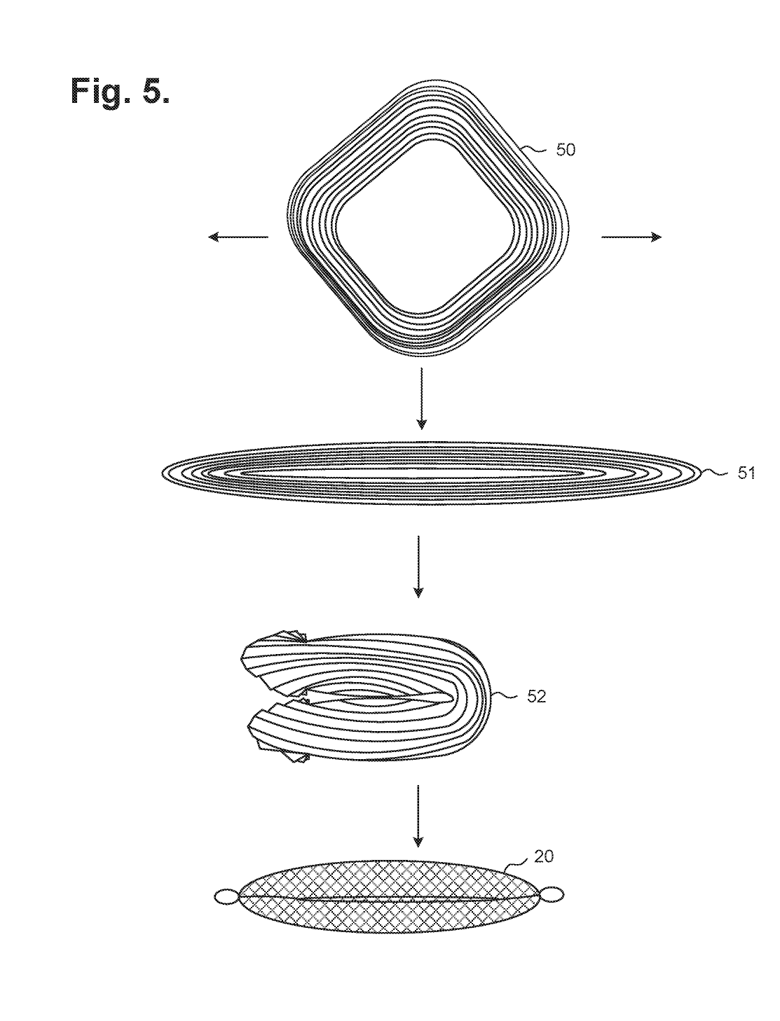

FIG. 5 is a block diagram illustrating an exemplary method for folding and covering the one or more sheets of adsorbent material. When the spinning wheel 42 has four arms 45, as in the embodiment shown, the spun material forms a square-like shape 50, having four corners. According to this embodiment, once removed from the spinning wheel, the square-like shape 50 can be pulled, on two of the four corners, in two opposite directions, creating an oval-like shape 51. The oval-like shape 51 is then folded at least one time, creating a bundle 52. The number of folds depends on a desired length and width of the boom 20. The bundle 52 is then surrounded by a cover and finalized to create the sorbent boom 20, described in greater detail above. When the spinning wheel 42 has only two arms 45, the step of pulling and folding the spun material 50 may not be necessary, based on the desired size of the sorbent boom 20 to be constructed, since the sheets of adsorbent material 21 will already be in the form of a bundle after spinning.

It is specifically intended that the apparatus and method are not to be limited to the embodiments and illustrations contained herein, but include modified forms of those embodiments including portions of the embodiments and combinations of elements of different embodiments as come within the scope of the claims. Modifications and alternative embodiments of various aspects of the apparatus and method will be apparent to those skilled in the art in view of this description. Accordingly, this description is to be construed as illustrative only and is for the purpose of teaching those skilled in the art the general manner of carrying out the invention. It is to be understood that the forms of the apparatus and method shown and described herein are to be taken as the presently preferred embodiments. Elements and materials may be substituted for those illustrated and described herein, parts and processes may be reversed, and certain features of the apparatus may be utilized independently, all as would be apparent to one skilled in the art after having the benefit of this description of the apparatus. Changes may be made in the elements described herein without departing from the spirit and scope of the apparatus as described in the following claims. In addition, any steps described herein with reference to the flow charts are not to be considered limiting and can include variations, such as additional steps, removed steps, and re-ordered steps.

What is claimed is:

1. A sorbent boom, comprising:
a bundle including one or more sheets of folded and spun adsorbent material, the bundle having a first longitudinal end and a second longitudinal end;
an exterior netting surrounding the bundle and having a first excess of netting at the first longitudinal end and a second excess of netting at the second longitudinal end;
a first clamp, securing the first excess of netting;
a second clamp securing the second excess of netting;
a first end ring secured within the first excess of netting;
a second end ring secured within the second excess of netting;
a rope extending longitudinally along the bundle, secured underneath the exterior netting; and
a clip secured to the rope and to the netting, the clip sized to connect to an end ring of another sorbent boom.

2. A sorbent boom, comprising:
a bundle including one or more sheets of adsorbent material, the bundle having a first longitudinal end and a second longitudinal end; and
an exterior cover surrounding the bundle.

3. The sorbent boom of claim 2, wherein the one or more sheets of adsorbent material are spun.

4. The sorbent boom of claim 3, wherein the one or more sheets of adsorbent material are folded.

5. The sorbent boom of claim 4, wherein the exterior cover includes a first excess of material at the first longitudinal end and a second excess of material at the second longitudinal end, the first excess of material secured by a first fastener and the second excess of material secured by a second fastener.

6. The sorbent boom of claim 5, wherein the exterior cover is comprised of netting.

7. The sorbent boom of claim 6, wherein the exterior cover directly contacts at least a portion of at least one of the one or more sheets of adsorbent material.

8. The sorbent boom of claim 7, further comprising a rope secured to the bundle, the rope extending longitudinally along the bundle, and a clip secured to the rope.

9. A method for constructing a sorbent boom, comprising:
forming one or more sheets of adsorbent material into a bundle, the bundle having a length, a first longitudinal end, and a second longitudinal end;
covering the bundle with an external cover; and
closing the external cover around the bundle.

10. A method as in claim 9, wherein the forming of the one or more sheets of adsorbent material into a bundle includes spinning the one or more sheets of adsorbent material.

11. A method as in claim 10, wherein the forming of the one or more sheets of adsorbent material into a bundle includes folding the one or more sheets of adsorbent material one or more times.

12. A method as in claim 11, wherein the covering of the bundle with an external cover includes placing the external cover directly over the bundle, such that the external cover directly contacts at least a portion of at least one of the one or more sheets of adsorbent material.

13. A method as in claim 12, wherein the closing of the external cover around the bundle includes securing a first fastener to the external cover at the first longitudinal end of the bundle and securing a second fastener to the external cover at the second longitudinal end of the bundle.

14. A method as in claim 13, further comprising attaching a ring to the external cover at the first longitudinal end of the bundle and attaching a second ring to the external cover at the second longitudinal end of the bundle.

15. A method as in claim 14, further comprising placing a rope along the length of the bundle, securing the rope to the bundle, and attaching a clip to the rope.
